(19) United States
(12) Patent Application Publication
(10) Pub. No.: US 2016/0262594 A1
(43) Pub. Date: Sep. 15, 2016

(54) Dishwasher Clean/Dirty Indicator

(71) Applicant: Henry Chan, New York, NY (US)

(72) Inventor: Henry Chan, New York, NY (US)

(21) Appl. No.: 15/065,738

(22) Filed: Mar. 9, 2016

Related U.S. Application Data
(60) Provisional application No. 62/131,141, filed on Mar. 10, 2015.

(51) Int. Cl. A47L 15/42; G08B 21/18

(52) U.S. Cl. CPC A47L 15/4293; G08B 21/18

(57) ABSTRACT

An automatic indicating device showing the clean or dirty state of items in a dishwasher using a cycle sensor, a sensor to detect when the dishwasher door is open, user input for toggling states, and logic to determine the correct state to display.

### CROSS-REFERENCE TO RELATED APPLICATIONS

This application claims the benefit of U.S. Provisional Application No. 62/131,141 filed Mar. 10, 2015.

### FEDERALLY SPONSORED RESEARCH OR DEVELOPMENT

Not Applicable.

### SEQUENCE LISTING, A TABLE, OR A COMPUTER PROGRAM LISTING COMPACT DISK APPENDIX

Not Applicable.

### BACKGROUND OF THE INVENTION

1. Field of the Invention

The present disclosure relates generally to dishwashers, and more particularly, to dishwasher status indicators that indicate whether dishes in a dishwasher are dirty or clean.

2. Description of the Prior Art

There are many times when a user may not sure about the cleanliness of the dishes in a dishwasher. Typically after a dishwashing cycle is complete on an automatic dishwasher, the user has the option to open the dishwasher, remove one or more dishes as they are needed and close the dishwasher, or the user can proceed to remove all the clean dishes from the dishwasher at once, leaving it ready for dirty dishes to be loaded. After a period of time after the cycle is complete, it can become ambiguous whether or not the dishes in the dishwasher are clean or dirty. This ambiguity is especially common in households having more than one member accessing the dishwasher, or with users who rinse dishes before placing them into the dishwasher.

Current solutions available are problematic. Some dishwashers include a cycle-complete indicator light that illuminates when the cycle is complete. These indicators turn off the next time the dishwasher door is closed, rendering them useless for subsequent openings and closings of the dishwasher door until another cycle is run.

Other problematic solutions to this problem include the use of a sign which a user would flip and post next to or on the front of the dishwasher door, telling others that the dishes inside the dishwasher are either clean or dirty. However, this solution can fail when the user forgets to set the sign, fooling people accessing the dishwasher later. Other solutions have included mechanical devices that when inserted inside a dishwasher will collect water in a basin during a cleaning cycle to activate an element to indicate cleanliness. The problem with this type of solution is that differences in water patterns, placement of the device, and whether or not a dishwasher is a water conserving model can affect whether enough water will be collected to trigger the element. Even when the mechanical element activates correctly, the user is still required to manually reset the device when loading dirty dishes.

When these existing problematic solutions fail often enough, users will tend to ignore what the sign or mechanical device indicates and resort to such time consuming and error-prone methods such as visual inspection and olfactory examination of the dishes inside the dishwasher to determine if they are clean or not. If a user thinks that the dishwasher hasn't been run yet when the dishes are actually clean, and proceeds to add a few dirty dishes to the dishwasher, the user will end up contaminating the entire batch of clean dishes. A user not knowing that the dishes have already been cleaned might end up running another cycle, cleaning already cleaned dishes and wasting resources. Not knowing whether the dishes are clean or not increases the risk of consuming foods and beverages from dirty dishes, potentially resulting in illness.

### BRIEF SUMMARY OF THE INVENTION

The Dishwasher Clean/Dirty Indicator of the present invention is an automatic electronic indicator for displaying whether the dishes inside a dishwasher are clean or dirty. The invention employs a sensor to determine whether the dishwasher door is open, a sensor to determine whether a cycle has completed, a provision for user input, and a clean/dirty status indicator controlled by electronic logic. The dishwasher clean/dirty indicator of the present invention eliminates the need to manually set whether the dishes are clean or dirty and eliminates reliability problems inherent in mechanical dishwasher clean/dirty indicating devices.

### BRIEF DESCRIPTION OF THE DRAWINGS

FIG. 1 is a front view of the preferred embodiment of the dishwasher clean/dirty indicator of the present invention.

FIG. 2 is an exploded view of the preferred embodiment of the dishwasher clean/dirty indicator of the present invention.

FIG. 3 is a block diagram of the operation of the dishwasher clean/dirty indicator of the present invention.

FIG. 4 is a schematic diagram of a preferred embodiment of the control circuit used in the dishwasher clean/dirty indicator of the present invention.

FIG. 5 is a flowchart of the operation of the firmware embedded within the microcontroller used in the preferred embodiment of the dishwasher clean/dirty indicator of the present invention.

FIG. 6 is a flowchart of push button operation of the firmware embedded within the microcontroller in the preferred embodiment of the dishwasher clean/dirty indicator of the present invention.

FIG. 7 is a schematic diagram of the electronic circuitry of an alternative embodiment of the dishwasher clean/dirty indicator of the present invention.

### DETAILED DESCRIPTION OF THE INVENTION

Embodiments to be preferred of the Dishwasher Clean/Dirty Indicator of the present invention are here and in figures disclosed.

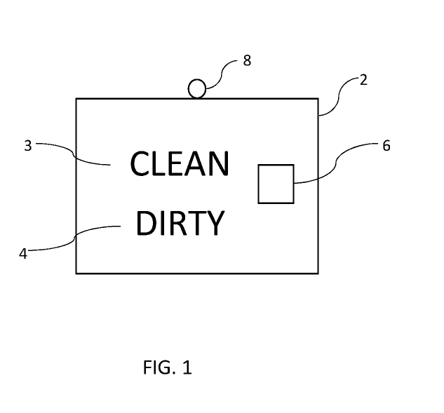

Referring to the invention in more detail, in FIG. 1 there is shown a housing 2 with a translucent material making up “CLEAN” indicator 3 and a “DIRTY” indicator 4. The indicators 3 and 4 are illuminated by light-emitting diodes behind housing 2 such that when either indicator is lit, it is clearly visible by a user when accessing the dishwasher. Located also on the face of the invention is a pushbutton 6 which allows the user to control the invention. Also attached to housing 2 is a method of attachment to a dishwasher rack which, in the preferred embodiment, is loop 8, for a hook.

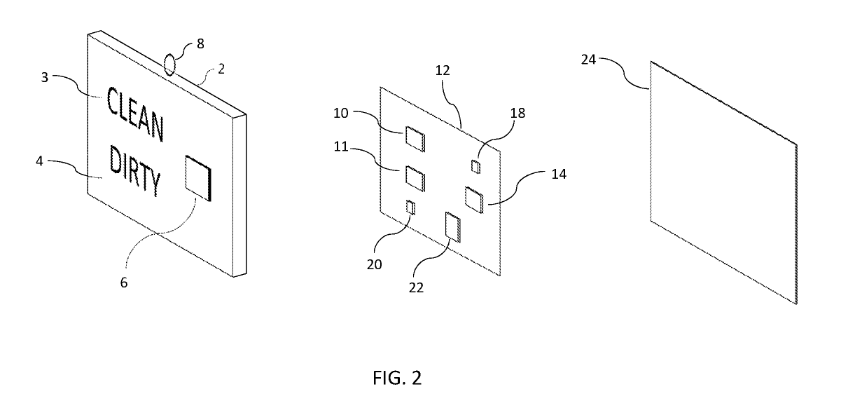

In further detail, FIG. 2 shows an exploded view of the invention. The figure shows housing 2 with a translucent material making up “CLEAN” indicator 3 and “DIRTY” indicator 4. Indicators 3 and 4 are illuminated by light-emitting diodes 10 and 11 behind housing 2 such that when either indicator is lit, it is clearly visible by a user when accessing the dishwasher. Circuit board 12 contains the electronics needed to perform the functions of the invention. Located also on the face of the invention is a pushbutton 6 which when pushed activates switch 14, allowing the user to control the invention. Additionally, light sensor 18 and heat sensor 20 feed light and temperature information to logic circuit 22, which in the preferred embodiment is a microcontroller. In the preferred embodiment, light is used to determine whether the dishwasher door is open. The presence of sufficient light indicates a door-open state; a very low light situation indicates a door-closed state. It is to be appreciated that the door does not have to be completely closed to block ambient light from reaching light sensor 18. This method of detecting the state of the door allows a door even left slightly ajar to be detected as closed. A battery (not shown) can be mounted on circuit board 12, which would provide power to the electronics. An alternative embodiment may consist of a power source external to the housing 2 delivering power wirelessly, for example through induction or visible or non-visible light. Attached to housing 2 is a method of attachment to a dishwasher rack, as in the preferred embodiment, an eye hole 8 for a hook. Back plate 24 provides a cover for housing 2, keeping electronics located on circuit board 12 free from moisture.

It is to be appreciated that the dishwasher clean/dirty indicating device of the present invention can be mounted externally to the dishwasher instead of internally on the dish rack. The entire dishwasher clean/dirty indicator of the present invention could be built sufficiently thin such that it can be mounted on the top edge of the dishwasher door, hidden under the front edge of the countertop when the door is closed in a typical dishwasher installation. This mounting method enables the invention to detect the presence of ambient light when the dishwasher door is open, and the reduced ambient light underneath the countertop when the door is closed. Heat from the running of the dishwasher cycle is detected by heat sensor 20 indirectly through the heat leaked from the inside of the dishwasher cabinet.

Still referring to FIG. 2, in the preferred embodiment, water-tight housing 2 can be made of a translucent material such that light can enter the housing and impinge on light sensor 18. The housing would also allow light to exit where LED (light-emitting diode) indicators 10 and 11 are mounted. An opaque material can also be used as part of housing 2 but provisions for light transmission around light sensor 18 and LED indicators 11 and 12 would be needed. While housing 2 is depicted in FIG. 1 and FIG. 2. as rectangular, it may be of any shape without altering the function of the invention. The dishwasher clean/dirty indicator of the present invention may also be simply placed onto the dishwasher rack, avoiding the need to hang the invention from the dishwasher rack.

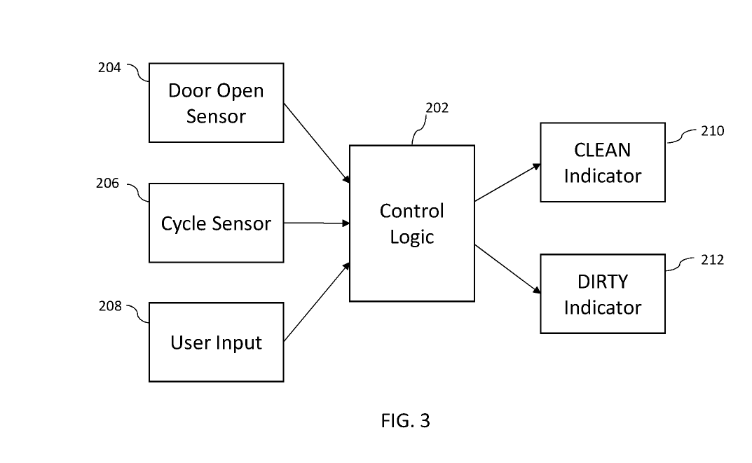

Referring now to FIG. 3, there is shown a block diagram with a high level view of the control system of the current invention. At the inputs to the control logic circuit 202 are door open sensor 204, which in the preferred embodiment is a light sensor, a cycle sensor 206 to detect the activation of a dishwasher wash cycle, which in the preferred embodiment is a temperature sensor, and a provision for user input 208, which in the preferred embodiment is a pushbutton switch. Logic in control logic circuit 202 determines if the Clean indicator 210 or the Dirty indicator 212 should be active. In the preferred embodiment, control logic circuit 202 comprises a microcontroller circuit preprogrammed with the microcode needed to control the invention.

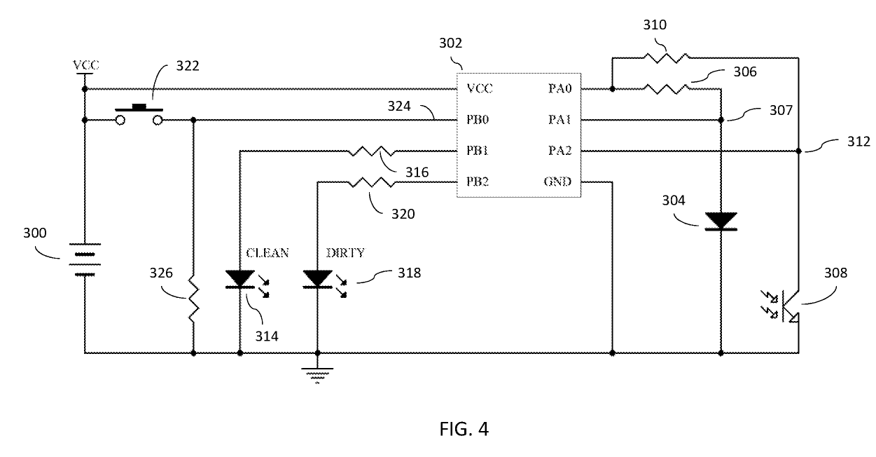

In further detail, FIG. 4 shows a schematic diagram of the electronic circuitry used in the preferred embodiment of the dishwasher clean/dirty indicator of the present invention. Battery 300 provides power to microcontroller 302. Microcontroller 302 is used to keep track of the clean or dirty state of the dishes. Diode 304, which is used as a temperature sensor, may be a silicon diode whose temperature coefficient is known. Resistor 306 establishes a bias current through diode 304, causing a temperature-dependent voltage to appear at input port 307 of microcontroller 302.

Still referring to the preferred embodiment in FIG. 4, light is detected using a light sensitive electronic component, such as phototransistor 308. Other visible light sensitive components may be used, including but not limited to a photodiode, photocell or a photo-resistor. Resistor 310 provides a bias current for phototransistor 308, creating a voltage at input port 312 of microcontroller 302. The detection of sufficient light signifies that the dishwasher door is open.

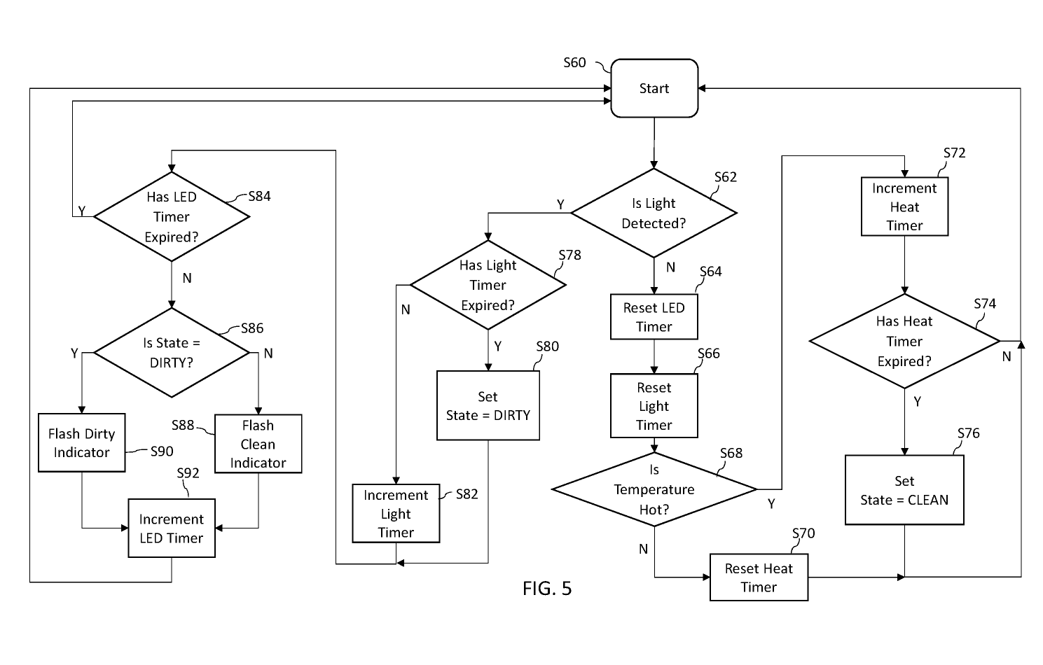

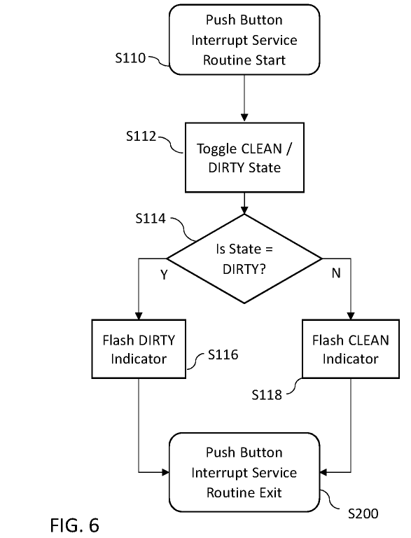

Still referring to the preferred embodiment in FIG. 4, microcontroller 302 executes firmware that has been stored internally. The operation of said firmware program is illustrated in FIG. 5 and FIG. 6. When said firmware program indicates that the Clean indicator needs to be illuminated, microcontroller 302 activates light-emitting diode 314, whose current is limited by resistor 316. Similarly, when the program indicates that the Dirty indicator needs to be illuminated, microcontroller 302 activates light emitting-diode 318 whose current is limited by resistor 320.

Still referring to the preferred embodiment in FIG. 4, a user can manually toggle the state of the Clean/Dirty indicator by pressing momentary switch 322. The supply voltage is then fed from battery 300 into input port 324 signifying a user input. Resistor 326 pulls down the voltage at input port 324 when switch 322 is released.

Operation of the Dishwasher Clean/Dirty Indicator:

Still referring to the preferred embodiment of the invention of FIG. 1:

There are two general ways users tend to use the dishwasher.
1) Bulk Remove Clean, Store Dirty: A user who operates in this manner usually removes all the clean dishes from the dishwasher at once after a cleaning cycle is complete, and uses the dishwasher to collect dirty dishes in between cleaning cycles. When the dishwasher is full of dirty dishes, the user then initiates a cleaning cycle.
2) Store Clean, Bulk Load Dirty—A user who operates in this manner usually leaves the clean dishes in the dishwasher after a cleaning cycle is complete, and takes out clean dishes to use as they are needed. Only when the dishwasher is almost empty or completely empty will a user unload any remaining clean dishes and load dirty dishes in bulk into the dishwasher to prepare for a new cycle.

Either way, the present invention would service the needs of both types of usage without manual intervention.

To use the present invention, the user would install the dishwasher clean/dirty indicator into the dishwasher. When the dishwasher clean/dirty indicator determines that the dishes have been cleaned, the state of the device is transitioned from Dirty to Clean. When the user opens up the dishwasher after the cycle is complete, the user sees an indication that the dishes are clean. The dishwasher clean/dirty indicator will now time how long the dishwasher is left open.

If the dishwasher door is open for longer than a predetermined period of time, for example, 2 minutes, it would indicate that the user has proceeded to empty all the clean dishes from the dishwasher and the dishwasher would be left empty. At this point, the internal state of the dishwasher clean/dirty indicator would automatically transition to Dirty. The dishwasher clean/dirty indicator would indicate to users that the dishes are dirty subsequently until the user starts a new cleaning cycle. When the user initiates the cleaning cycle, the dishwasher clean/dirty indicator would detect that the cycle has progressed sufficiently after a predetermined period of time and would automatically transition from the Dirty state to the Clean state.

If instead, the user only opens the dishwasher door for a short period, for example to take out only one or a few items, and closes the door immediately, the internal state of the dishwasher clean/dirty indicator would still indicate Clean. That way, subsequent accesses of the dishwasher would still indicate the clean state of the dishes. When most or all the clean dishes have been used up, the user would load dirty dishes in bulk. At this point, the dishwasher clean/dirty indicator would transition to the Dirty state because the door would have been open for more than a predetermined amount of time to facilitate the bulk loading of dirty dishes.

The user has the ability to manually toggle the Clean/Dirty state by pressing and releasing the momentary switch. This allows a user to manually signify the Dirty state if, for example, the user accidentally drips dirty liquids over the dishes, contaminating the contents of the dishwasher.

Detailed Description of Firmware Operation in the Preferred Embodiment:

Referring to FIG. 5, the flow of execution of the program in the microcontroller in the preferred embodiment starts at state S60. In the next step S62, the light sensor is checked to detect if the dishwasher door is open. If the door is open, then light will be detected, and execution would flow to S78. At S78, the light timer is checked to see if it has expired. This timer is used to keep track of how long the door has been opened for. If the timer has expired, indicating that the dishwasher door was open long enough to empty all the dishes, then the state would be set to Dirty at S80. If the light timer has not expired, execution would flow to S82, incrementing the light timer. After S80 and S82, execution would flow to S84. At S84, the LED timer is checked to ensure that the LED is not left on for too long to conserve energy. If the LED timer has expired, then the execution returns to the beginning state S60. If the LED timer has not expired, the flow of execution will transition to S86, where the Clean/Dirty state is examined. If the state is Clean, then S88 will execute, flashing the Clean indicator. If the state is Dirty, S90 will execute, flashing the Dirty Indicator. After either indicators are flashed, the flow of execution continues to S92, incrementing the LED timer. The flow then returns to the Start S60.

Still referring to FIG. 5, if during step S62, no light is detected, execution flows through S64, where the LED timer is reset and through S66 where the light timer is reset, and subsequently to S68 where the temperature as measured in the sensor is checked. If said temperature exceeds a threshold that indicates a cleaning cycle is being activated, execution moves to S72. Otherwise, if said temperature does not exceed said threshold, the heat timer is reset at S70 and flow returns to the beginning at S60. If sufficient heat is detected, the heat timer is incremented at S72 to keep track of how long heating has been occurring. At S74, the heat timer is checked to determine if there has been heating for sufficiently long to indicate that a cleaning cycle has made significant progress. If so, the internal state is set to Clean at S76. Otherwise, control returns to the start of the program at S60.

Operation of the Manual Switch:

Referring to FIG. 6, showing the flow of execution of the program embedded in the preferred embodiment, the subroutine is entered when the momentary switch is activated at state S110. The flow of execution moves to S112, which toggles the Clean/Dirty state. The Clean/Dirty state is checked at step S114. If the Clean/Dirty state is Dirty, the Dirty indicator is flashed at step S116 and the flow of execution exits the subroutine at S200. If the Clean/Dirty state at S114 is Clean, the Clean Indicator is flashed at step S118 and the flow of execution exits the subroutine at S200.

It is to be appreciated that the LED's used to produce a visual indication for Clean and Dirty can be replaced or augmented through the use of an audio device such as a beeper or voice synthesizer, or a wireless link, or a electro-mechanically actuated sign without altering the inventive concepts and principles embodied therein.

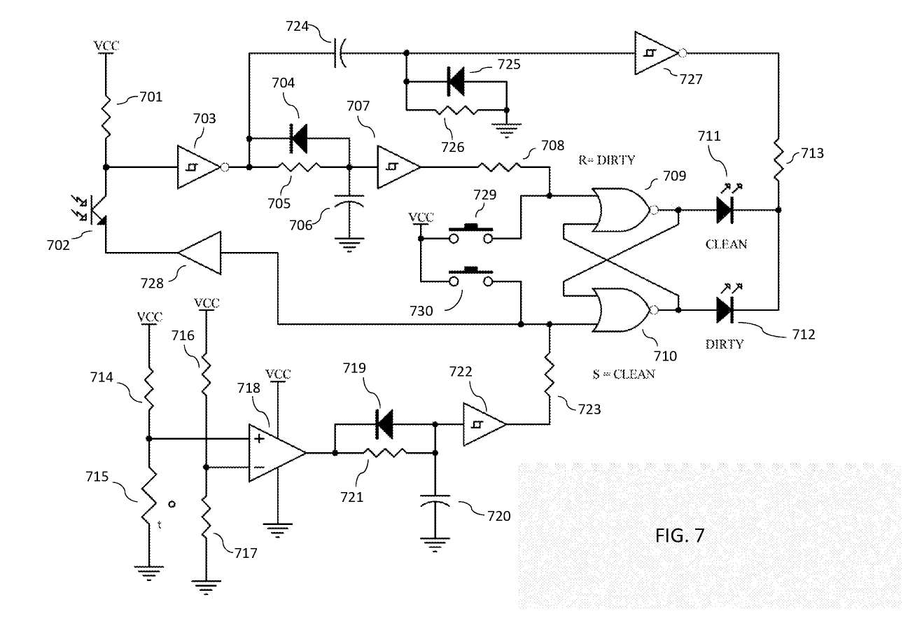

An alternative embodiment of the present invention is shown in FIG. 7. This alternative embodiment does not necessitate the use of firmware embedded on a microcontroller. Instead, logic circuits and analog timers are used.

Still referring to FIG. 7, phototransistor 702 is used to detect the presence of light, indicating whether or not the dishwasher door is open. Resistor 701 limits the current to phototransistor 702. Buffer 728 is normally in the low state, allowing current to flow out of the phototransistor. The voltage detected at the input of Schmitt-trigger inverter 703 would be a voltage above the midpoint between the two voltages VCC and ground. When a sufficient amount of light falls on the phototransistor 702, the voltage at the input of Schmitt trigger/inverter 703 would be low. Schmitt-trigger inverter 703 converts the slowly changing analog voltage to a digital output and produces a logic high output when light is detected. The logic high is fed to resistor 705 and capacitor 706 which form a delay timer circuit. As capacitor 706 charges from the logic high, the voltage across capacitor 706 slowly rises. The values of resistor 705 and capacitor 706 are chosen such that the time it takes to charge to a sufficient level given a steady high logic input is a predetermined amount of time, such as 2 minutes, after which the dishes would be considered dirty.

When the slowly rising voltage from capacitor 706 triggers the non-inverting Schmitt-trigger 707 to go high, the voltage is applied through current limiting resistor 708 to the Reset input of an SR flip-flop formed by NOR gates 709 and 710. The logic high at the reset input causes the SR flip flop to reset, representing the DIRTY state. Diode 704 is used to quickly discharge timing capacitor 706, thus resetting the timer when light is not detected.

Still referring to FIG. 7, the circuitry for detecting a cleaning cycle indirectly by detecting the rise in temperature inside the dishwasher is accomplished through thermistor 715 and resistor 714, in conjunction with a voltage reference formed by resistor 716, resistor 717 and voltage comparator 718. When the temperature sensed at positive temperature coefficient thermistor 715 rises, the voltage to the input of comparator 718 rises. The reference voltage at the negative input of comparator 718 is set by resistors 716 and 717. When the voltage rises above the predetermined reference voltage, which is chosen to correspond to the elevated temperature of a dish cleaning cycle, comparator 718 outputs a high signal. This high signal is input into a delay timer circuit formed by capacitor 720 and resistor 721. The values of resistor 721 and capacitor 720 are chosen such that the time it takes to charge capacitor 720 through resistor 721 when comparator 718 produces a continuous logic high signal corresponds to a predetermined length of time to indicate that the high-temperature portion of the cleaning cycle has mostly completed, for example, 20 minutes. When the voltage at capacitor 720 reaches a sufficient level, non-inverting Schmitt trigger 722 is triggered, producing a logic high output through resistor 723 at the SET input of the SR flip-flop formed by NOR gates 709 and 710. The flip-flop is then set, representing the CLEAN state of the dishes. Diode 719 is used to quickly discharge capacitor 720 thus resetting the timer in the event the temperature drops below the reference point.

To indicate to the user the state of the dishes when the dishwasher door is first opened, the light detection signal at the output of Schmitt-trigger inverter 703 is also passed through a one-shot timer made up of capacitor 724, resistor 726 and diode 725. As capacitor 724 charges through resistor 726, the voltage at the input of Schmitt trigger/inverter 727 is initially high, and slowly drops to a low voltage level approaching zero when the capacitor charging stops. The initial high signal at Schmitt-trigger inverter 727 is inverted to a logic low signal. Light-emitting diode 711, representing the CLEAN state, is connected to the non-inverting output of SR flip-flop formed by NOR gates 709 and 710. Light-emitting diode 712, representing the DIRTY state, is connected to the inverting output of said flip flop. When the output of Schmitt trigger/inverter 727 goes low, LED 711 or LED 712 can conduct through the inverter, illuminating either LED 711 indicating a CLEAN state, or LED 712 indicating a DIRTY state.

It is to be appreciated that additional circuitry such as an astable multivibrator circuit or other oscillator may be used to control LED 711 and LED 712 such that they flash or fade gradually from low brightness to full brightness and back to low brightness, drawing attention from the user.

When the voltage at the input of Schmitt-trigger inverter 727 nears zero as timing capacitor 724 stops charging, the output of said Schmitt Trigger/inverter goes high, preventing LED's 711 and 712 from conducting, shutting them off. The values of capacitor 724 and resistor 725 are chosen such that the time it takes to charge said capacitor through said resistor is a predetermined length of time, such as 5 seconds, after which indicator LED's 711 and 712 shut off to conserve power. Diode 725 provides a path to discharge capacitor 724 when the output of Schmitt-trigger inverter 703 goes low, resetting the timer.

Still referring to FIG. 7, if the user needs to manually set the Clean or Dirty state, the user can do so using momentary switches 729 and 730. If the user activates switch 729 to set the Dirty state, a logic high signal is sent to the Reset input of SR flip-flop formed by NOR gates 709 and 710, causing said flip-flop to reset, representing the Dirty state. If the user activates switch 730 to set the Clean state, a high logic signal is sent to the Set input of said SR flip-flop, causing said flip-flop to be set, representing the Clean state. Buffer 728 resets light sensing circuitry when switch 730 is activated so that said SR flip flop does not reset immediately after the user sets the Clean state manually.

It is to be appreciated that while the embodiment depicted in FIG. 7 uses two momentary switches to allow the user to toggle between Clean and Dirty states, a single switch may be used along with additional logic circuitry to toggle between states.

It is to be appreciated that while the embodiments depicted in both FIG. 4 and FIG. 7 comprise momentary switches to allow the user to toggle between the Clean and Dirty states, other sensors may be incorporated instead to allow the user to toggle between said Clean and Dirty states, such as a touch sensor or an accelerometer.

Closing Statement:

Having thus described in detail preferred embodiments of the Dishwasher Clean/Dirty Indicator of the present invention, it is to be appreciated and will be apparent to those skilled in the art that many changes not exemplified in the detailed description of the invention could be made without altering the inventive concepts and principles embodied therein. It is also to be appreciated that numerous embodiments incorporating only part of the preferred embodiment are possible which do not alter, with respect to those parts, the inventive concepts and principles embodied therein. The presented embodiments are therefore to be considered in all respects exemplary and/or illustrative and not restrictive, the scope of the invention being indicated by the appended claims, and all alternate embodiments and changes to the embodiments shown herein which come within the meaning and range of equivalency of the appended claims are therefore to be embraced therein.

I claim:

1. A dishwasher indicating device for indicating the cleanliness of items in a dishwasher comprising:
a. At least one sensor capable of detecting whether or not the door of said dishwasher is open;
b. At least one sensor capable of detecting whether or not a cleaning cycle of said dishwasher is running;
c. a timer for measuring the amount of time said dishwasher door is open;
d. a timer for measuring the amount of time said dishwasher cycle is running;
e. a control circuit, capable of determining the state of cleanliness of the dishes based on the time that said dishwasher door is open and the time said dishwasher cycle is running; and
f. at least one indicator responsive to said state of cleanliness of said items in said dishwasher as determined by said control circuit.

2. The dishwasher indicating device of claim 1, futher comprising at least one sensor for user input connected to said control circuit.

3. The dishwasher indicating device of claim 1 wherein at least one sensor capable of detecting whether or not the door of said dishwasher is open comprises at least one light detecting device.

4. The dishwasher indicating device of claim 1 wherein at least one sensor capable of detecting whether or not said dishwasher cycle is running comprises at least one sensor responsive to temperature.

5. The dishwasher indicating device of claim 1 wherein the control circuit comprises at least one microcontroller.

6. The dishwasher indicating device of claim 1 wherein the control circuit comprises a plurality of logic gates.

7. The dishwasher indicating device of claim 2 wherein at least one sensor for user input comprises at least one switch.

8. The dishwasher indicating device of claim 2 wherein at least one sensor for user input comprises at least one motion sensor.

9. The dishwasher indicating device of claim 1 wherein at least one indicator comprises at least one light-emitting device.

10. The dishwasher indicating device of claim 1 wherein at least one indicator comprises at least one audible alert.

11. The dishwasher indicating device of claim 1 wherein at least one indicator is connected to at least one wireless communications circuit.

12. A dishwasher indicating device for indicating the cleanliness of items in a dishwasher comprising:
a. at least one sensor responsive to ambient light;
b. at least one sensor responsive to temperature;
c. a timer for measuring the amount of time light has been detected;
d. a timer for measuring the amount of time a temperature of a predetermined level has been detected;
e. a control circuit, capable of determining the state of cleanliness of the dishes based on said timer for measuring the amount of time light has been detected, and said timer for measuring the amount of time a temperature of a predetermined level has been detected;
f. at least one device for user input connected to said control circuit; and
g. at least one indicator responsive to said state of cleanliness as determined by said control circuit.

13. A method for determining the cleanliness of dishes in a dishwasher comprising the steps of:
a. detecting whether or not said dishwasher door is open;
b. timing the length of time that said dishwasher door is open;
c. detecting whether or not a cleaning cycle in said dishwasher is running;
d. timing the length of time that said cleaning cycle is running;
e. determining the state of cleanliness of said dishes in said dishwasher based on the length of time said cleaning cycle has been running and the length of time said dishwasher door is open; and
f. indicating to the user said state of cleanliness of said dishes.

14. The method of claim 13 wherein the step of detecting whether said dishwasher door is open is accomplished by detecting the presense of light in the interior of said dishwasher.

15. The method of claim 13 wherein the step of detecting whether said dishwasher door is open is accomplished by detecting the presense of light at the exterior of said dishwasher.

16. The method of claim 13 wherein the step of detecting whether a cleaning cycle is running in said dishwasher is accomplished by sensing the temperature of the interior of said dishwasher.

17. The method of claim 13 wherein the step of detecting whether a cleaning cycle is running in said dishwasher is accomplished by sensing the temperature at the exterior of said dishwasher.

18. The method of claim 13 wherein the indicating step is accomplished by illuminating a light-emitting device.

19. The method of claim 18 wherein the indicating step further comprises producing an audible alert.

20. The method of claim 18 wherein the indicating step further comprises transmitting an alert wirelessly to a device remotely located from said dishwasher.
